(19) United States
(12) Patent Application Publication
(10) Pub. No.: US 2008/0299302 A1
(43) Pub. Date: Dec. 4, 2008

(54) METHOD OF MANUFACTURING AN OPTICAL ELEMENT FROM SILICA OR GLASS

(75) Inventor: Guillaume RAVEL, Grenoble (FR)

Correspondence Address: OBLON, SPIVAK, MCCLELLAND MAIER & NEUSTADT, P.C., 1940 DUKE STREET, ALEXANDRIA, VA, 22314, US

(73) Assignee: COMMISSARIAT A L'ENERGIE ATOMIQUE, Paris (FR)

(21) Appl. No.: 12/129,929

(22) Filed: May 30, 2008

(30) Foreign Application Priority Data
Jun. 4, 2007 (FR) 07 55445

(51) Int. Cl. B05D 5/06

(52) U.S. Cl. 427/162

(57) ABSTRACT

The invention concerns a method of manufacturing an optical element made from silica, characterised in that it comprises at least one step of depositing silica on at least one face of the optical element.

The invention applies more particularly to the manufacture of phase plates.

### TECHNICAL FIELD AND PRIOR ART

The invention concerns a method of manufacturing an optical element from silica or glass.

The traditional method of manufacturing micro-optical elements, such as microlenses with an arbitrary profile, the gratings, plates and phase masks are grouped together in various techniques, namely:

direct laser writing,

reactive ion machining etching, associated with photolithography,

the injection of plastics into moulds,

embossing under ultraviolet.

When the objects to be manufactured are made from silica or glass, for high-tech applications (such as phase plates used for correcting power laser beams), only laser writing and photolithography techniques are used.

Improvements to these two techniques have been developed. Thus reflow of the masking resin makes it possible to obtain the transfer of a non-abrupt profile in the silica during the etching step. The fineness of etching can also be improved by using resin insulation techniques involving an interference mechanism (a so-called interferometric lithography technique). Advanced electron-beam lithography techniques can also be used.

All these techniques based on photolithography in fact include an etching step, that is to say, a step during which material is removed.

With regard to the techniques based on direct laser writing, either they proceed by structuring of the resin and consequently involve a subsequent etching step using the structured resin as a mask, or they proceed by direct interaction with the material and then laser ablation is then spoken of since the material is directly removed from the area of the surface swept by the laser beam. It is therefore also a case here of a technique based on the removal of material.

The known methods of manufacturing or machining silica or glass components therefore all comprise steps during which material is removed, then requiring the intervention of numerous tools and/or numerous different products (laser, UV source, vacuum pump, solvents, masking resins, etc.). The invention does not have this drawback.

### DISCLOSURE OF THE INVENTION

This is because the invention concerns a method of manufacturing an optical element, characterised in that it comprises at least one step of depositing silica on at least one face of an optical silica or glass substrate.

The silica deposited on the face of the optical substrate is formed by the succession of the following elementary steps:

formation, from a gas, of excited or unstable components in a chamber, the walls of which form two electrodes between which a high voltage is applied,

discharge of the excited or unstable components formed in the chamber into a post-discharge zone into which a precursor gas containing silica molecules is introduced,

formation, in the post-discharge zone, of silica molecules following the interaction of the precursor gas with the excited or unstable components,

conduction of the silica molecules formed in the post-discharge zone as far as the face of the optical substrate by means of a capillary tube.

Preferentially, the formation of excited or unstable components in a chamber takes place at atmospheric pressure.

According to an improvement to the method of the invention, the capillary tube is moved above the face of the optical substrate.

The method of the invention advantageously applies to the manufacture of phase plates.

Based on a technique of localised deposition of silica, the method of the invention advantageously allows the direct production of the silica profiles sought by a controlled addition of the silica.

### BRIEF DESCRIPTION OF THE FIGURES

Other characteristics and advantages of the invention will emerge from a reading of a preferential embodiment of the invention given with reference to the accompanying figures, among which:

FIG. 1 depicts an outline diagram of a device for implementing the method of the invention;

FIG. 2 illustrates, by means of a photograph, an example of patterns obtained by the method of the invention.

### DETAILED DESCRIPTION OF A PREFERENTIAL EMBODIMENT OF THE INVENTION

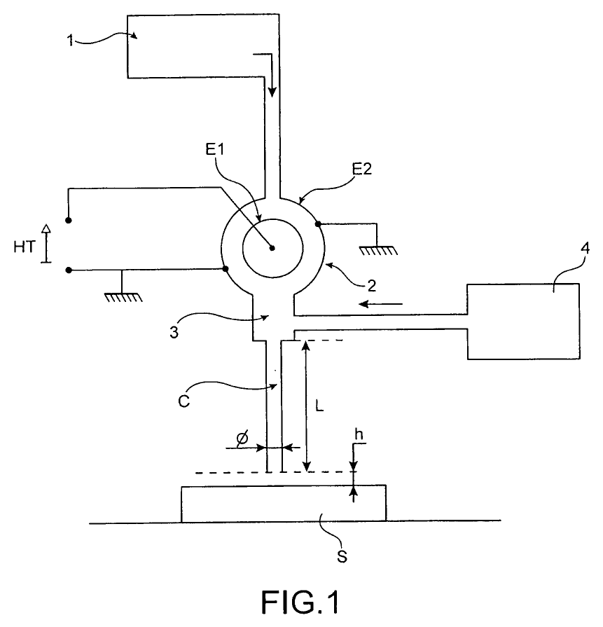

FIG. 1 depicts an outline diagram of a device for implementing the method of the invention.

The invention comprises a gas source 1, a chamber 2 for forming excited or unstable components, a post-discharge cavity 3, a precursor gas source 4 and a capillary tube C. The chamber 2 for forming excited or unstable components comprises two electrodes E1 and E2, between which a high-voltage HT is applied, a high voltage whose level varies for example from a few hundreds of volts to a few thousands of volts. The gas source 1 contains a gas or a mixture of gases such as for example nitrogen (N₂), oxygen (O₂), a mixture of nitrogen and oxygen, and air. When the gas or mixture of gases coming from the gas source 1 enters the chamber 2, there is the formation of excited or unstable gaseous components. The excited or unstable components that are formed in the chamber 2 next enter the post-discharge cavity 3. The post-discharge cavity 3 is a confinement zone where the chemical reactions are facilitated. The precursor gas, for example hexamethyldisilane ((Si—(CH₃)₃)₂), hexamethyldisiloxane ((CH₃)₃—Si—O—Si—(CH₃)₃), or hexamethyldisilazane ((CH₃)₃—Si—N—Si—(CH₃)₃), which comes from the source 4 and enters the cavity 3, then allows the formation of silica molecules. The capillary tube C conducts the silica molecules as far as the surface of an optical substrate S (made from silica or glass), where they are deposited. The distance h that separates the capillary tube C from the substrate S is for example between 5 and 20 mm. In a manner known per se, the thickness of silica deposited is controlled by means of control parameters commonly used in plasmagenic devices (the power of the electrical source, gas flow rates, etc.) The deposition rate is for example between 1 nm and 10 nm per minute.

In a particularly advantageous embodiment of the invention, the capillary tube is moved by a robot (not shown in the figure) so that the capillary tube can describe the entire surface of the substrate. An optical device for measuring the thickness of the deposit, installed on the robot, for example an optical interferometry device, makes it possible to measure the local thickness of silica being deposited. The measurement of the thickness of deposit then participates in the control of the deposition. The presence of a robot for moving the capillary tube advantageously makes it possible for the deposition of silica to be carried out without interruption, or even simultaneously, on the two opposite faces of one and the same substrate S.

The method of manufacturing an optical element of the invention results in the production of profiles of the optical element in a considerably shorter time than the time needed by the etching techniques of the prior art, which often require several reworking steps in order to achieve the required aim.

Another advantage of the invention is the absence of post-etching cleaning steps, which steps are liable to leave residues on the surface of the substrate. It is then possible to envisage applications where the part produced has a high laser flux pass through it, such as for example wave-front correction lenses for power laser cavities.

Yet another advantage of the invention is the absence of any limitation on the size of the surface of the substrate to be processed.

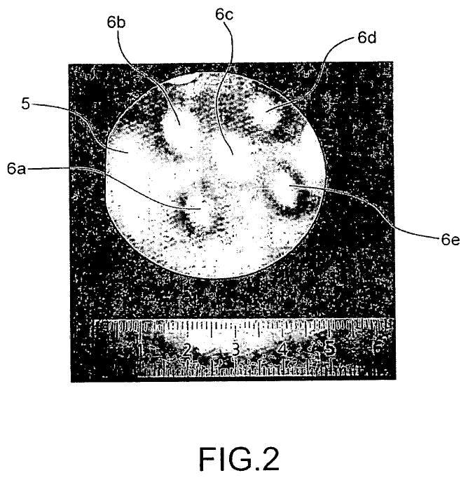

FIG. 2 illustrates, by means of a photograph, an example of patterns obtained by the invention. A structure 5 comprises a set of five elliptically shaped patterns 6a-6e. A scale in centimetres is shown on this photograph in order to make it possible to assess the size of the patterns. The height of the patterns is substantially equal to 100 nm. The optical index obtained for this structure is 1.45 for a wavelength of 600 nm.

1. Method of manufacturing an optical element, characterised in that it comprises the succession of the following elementary steps:
formation, from a gas, of excited or unstable components in a chamber (2), the walls of which form two electrodes (E1, E2) between which a high voltage (HV) is applied,
discharge of the excited or unstable components formed in the chamber (2) into a post-discharge zone (3) into which a precursor gas containing silica molecules is introduced,
formation, in the post-discharge zone (3), of silica molecules following the interaction of the precursor gas with the excited or unstable components,
conduction of the silica molecules formed in the post-discharge zone (3) as far as the face of the optical substrate (S) by means of a capillary tube (C), and
deposition, on the optical substrate (S), of the silica molecules conducted as far as the face of an optical substrate, in order to constitute the optical element.

2. Method according to claim 1, in which the formation of excited or unstable components in a chamber takes place at atmospheric pressure.

3. Method according to claim 1, in which the gas from which the excited or unstable components are formed is chosen from nitrogen (N₂), oxygen (O₂), a mixture of nitrogen and oxygen, and air.

4. Method according to claim 1, in which the precursor gas is hexamethyldisilane ((Si—(CH₃)₃)₂), hexamethyldisiloxane ((CH₃)₃—Si—O—Si—(CH₃)₃), or hexamethyldisilazane ((CH₃)₃—Si—N—Si—(CH₃)₃).

5. Method according to claim 1, in which the capillary tube (C) is moved above the face of the optical substrate.

6. Method according to claim 1, in which the thickness of the deposition of the silica molecules is controlled by an optical device.

7. Method according to claim 1, in which the optical element is a phase plate.
